(19) United States
(12) Patent Application Publication
(10) Pub. No.: US 2008/0005919 A1
(43) Pub. Date: Jan. 10, 2008

(54) IN-LINE DRYER

(76) Inventors: Jerome R. Brown, Barrington, IL (US); Benjamin A. Kawa, Salem, VA (US)

Correspondence Address: WILDMAN HARROLD ALLEN & DIXON LLP, 225 WEST WACKER DRIVE, SUITE 2800, CHICAGO, IL, 60606, US

(21) Appl. No.: 11/456,302

(22) Filed: Jul. 10, 2006

(51) Int. Cl. F26B 21/06

(52) U.S. Cl. 34/80; 34/DIG. 1

(57) ABSTRACT

An in-line dryer for connecting to a compressed fluid delivery line comprising a flexible, translucent housing having first and second ends and a desiccant material within the housing.

### FIELD OF THE INVENTION

This invention relates to in-line dryers and more particularly to in-line dryers adapted to remove water vapor from a flow of compressed fluid, such as air.

### BRIEF DESCRIPTION OF THE DRAWINGS

FIG. 1 is a side cross-sectional view of one example of the in-line dryer of the invention;

FIG. 2 is a side cross-sectional view of a second example of the in-line dryer of the invention;

FIG. 3 is a side cross-sectional view of a third example of the in-line dryer of the invention.

### SUMMARY

In one example, an in-line dryer for connecting to a compressed fluid delivery line is provided comprising a flexible, translucent housing having first and second ends and a desiccant material within the housing.

In another example, an in-line dryer for connecting to a compressed fluid delivery line is provided comprising a housing having first and second ends, a desiccant material disposed within the housing, and a particulate oil vapor absorbing material disposed within the housing between the desiccant material and the first end of the housing.

In another example, an in-line dryer for connecting to a compressed fluid delivery line is provided comprising a housing, first and second particulate materials disposed within the housing, and a barrier disposed within the housing between the first and second particulate materials.

### DETAILED DESCRIPTION

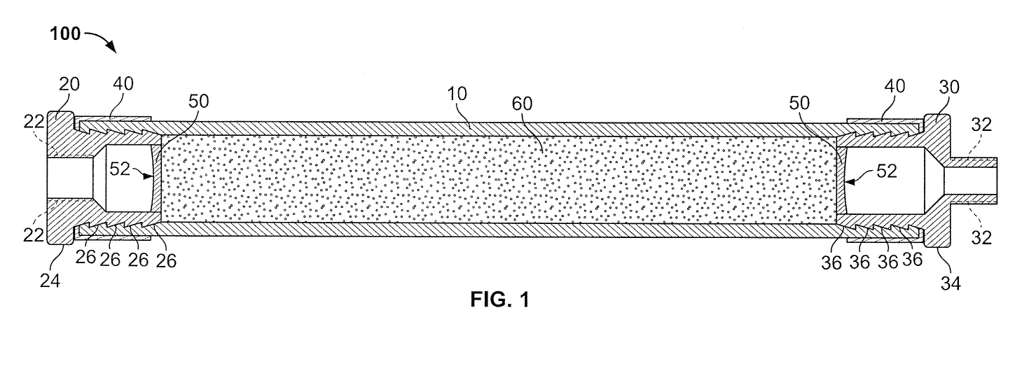

Referring to FIG. 1, one example of an in-line dryer 100 is shown having a housing 10, connectors 20 and 30, ferrules 40, filters 50, and desiccant material 60.

Housing 10 defines a passage for the flow of a compressed fluid, such as compressed air, and can have any geometry, such as cylindrical, trapezoidal, octagonal, etc. In addition, housing 10 can be made of various types of material, such as vinyl, rubber, plastic, PVC, metal, etc., depending on the intended application. The selection of the geometry and material for housing 10 depends on the strength required to contain the compressed fluid and the required operating pressure for the intended application.

In this example, housing 10 is made from flexible, reinforced, translucent ethyl vinyl acetate tubing that is approximately 23.5 inches long, has an inside diameter of approximately 1 inch, and has an outside diameter of approximately 1.312 inches. In particular, housing 10 is EVA series tubing from Kentak Products Company, which can be used for high pressure compressed air applications. The translucent or transparent characteristic of housing 10 is beneficial when an indicating desiccant is used. By using a translucent or transparent housing 10, or at least a portion thereof, a user can see the indicating desiccant change color and know when the desiccant is spent and in-line dryer 100 needs to be replaced. The particular EVA series tubing in this example is extruded ethyl vinyl acetate that is reinforced with polyester textile yarn, has a working pressure of 150 psi at 70° F., and an operating temperature range of −50° F. to +125° F., which provides sufficient strength to contain the compressed air at most operating pressures.

Connectors 20 and 30 are standard connectors used to connect to compressed fluid delivery lines. Many different type of connectors can be used and depending on the intended application, connectors 20 and 30 can both be male connectors, can both be female connectors, or can be one of each. In the example shown, connector 20 is a female type connector that is press fit into a first end of housing 10. In particular, connector 20 is an Arrow Pneumatics #HW101 connector having 0.25 inch NPT female threads 22, a 1.125 inch hex head 24, and barbs 26 that are used to grip the inside of housing 10 and secure connector 20 to housing 10. In addition, the inside diameter of connector 20 at the outside end of the connector is smaller than the inside diameter of connector 20 at the inside end of the connector, which prevents a pressure drop in the fluid as it passes through housing 10. Connector 30 is a male type connector that is press fit into a second end of housing 10. In particular, connector 30 is an Arrow Pneumatics #HW102 connector having 0.25 inch NPT male threads 32, a 1.125 inch hex head 34, and barbs 36 that are used to grip the inside of housing 10 to secure connector 30 to housing 10. In addition, the inside diameter of connector 30 at the outside end of the connector is smaller than the inside diameter of connector 30 at the inside end of the connector, which prevents a pressure drop in the fluid as it passes through housing 10.

Ferrules 40 are placed on the ends of housing 10 to assist in securing connectors 20 and 30 to the inside of housing 10. The inside diameter of ferrules 40 are approximately equal to the outside diameter of housing 10 and are used to compress housing 10 between ferrules 40 and barbs 26 and 36 of connectors 20 and 30. In this example, ferrules 40 are 24 gauge type 304 stainless steel cylinders having an inner diameter of approximately 1.375 inches and an outer diameter of approximately 1.423 inches. Alternatively, other devices and methods could be used to secure connectors 20 and 30 or if different connectors are used, ferrules 40 could be removed.

Filters 50 are press fit into connectors 20 and 30 to prevent desiccant 60 from migrating into connectors 20 and 30 and, depending on the type of filter used, can also be utilized to prevent dirt and other large particles from entering in-line dryer 100. Alternatively, filters 50 could also be press fit into housing 10 adjacent connectors 20 and 30, rather than into connectors 20 and 30 themselves. In addition, rather than a filter, an other means could be used to keep desiccant 60 within housing 10. In this example, filters 50 are sintered bronze dispersion filters that are used to secure the desiccant 60 and filter dirt and large particles. In particular, filters 50 are Arrow Pnuematics #HW104 sintered bronze dispersion filters made of grade 23, 150 micron bronze powder and have a diameter of approximately 0.769 inches, a thickness of approximately 0.13 inches, and one curved surface 52 having a radius of approximately 1.85 inches. Curved surface 52 makes filters 50 substantially stronger at the perimeter where it is thicker and enhances air flow at the center where it is thinner. In addition, filters 50 have edges that have a 2° draft to make the press fit into connectors 20 and 30 or housing 10 easier.

In this example, the compressed air or gas that is to be dried can enter housing 10 through connector 20 or connector 30. Thus, a user can connect either connector 20 or 30 to a hose to receive the compressed air or gas.

Desiccant 60 can be any type of material capable of absorbing water vapor from the air flowing through in-line dryer 100, such as silica gel, activated alumina, or a molecular sieve. In the example shown, desiccant 60 substantially fills housing 10 and is a particulate indicating desiccant, such as the 4-8 mm bead indicating silica gels sold by Kaltron-Pettibone, which changes color as desiccant 60 is spent. By using an indicating desiccant and a translucent or transparent housing, a user can easily determine when the desiccant is spent and when the in-line dryer 10 needs to be replaced. By using a color changing desiccant, a user can see the progression or rate at which the desiccant is being spent. This allows the user to plan ahead for its replacement.

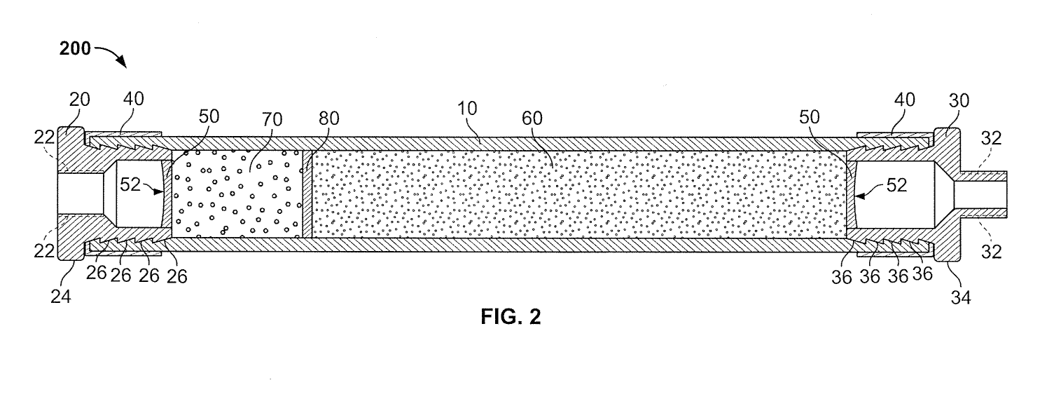

Referring to FIG. 2, a second example of an in-line dryer 200 is shown, which includes the same housing 10, connectors 20 and 30, ferrules 40, filters 50, and desiccant material 60 as shown in FIG. 1 and described above. In addition, in-line dryer 200 also contains oil vapor absorbing material 70 and permeable partition 80.

Oil vapor absorbing material 70 can be any type of material capable of absorbing oil vapor from the air flowing through in-line dryer 200, such as activated carbon materials, polymeric compounds, clays, or wool or other animal hairs, and is placed in housing 10 between desiccant 60 and connector 20. In the example shown, oil vapor absorbing material 70 is particulate activated carbon, such as the GC60 activated carbon pellets from Nucon International, Inc. or the AP3-60 or AP4-60 activated carbon pellets from Calgon Carbon Corporation. The ratio of oil vapor absorbing material 70 to desiccant 60 can vary based on the intended application. In the example shown, oil vapor absorbing material 70 fills approximately 20-40% of housing 10 and desiccant fills approximately 60-80% of housing 10.

In this example, oil vapor absorbing material 70 is positioned at an end of housing 10 in which the compressed air or gas enters housing 10. In this construction, oil vapor is absorbed in oil vapor absorbing material 70 before the air contacts desiccant 60.

Permeable partition 80 is used to prevent oil vapor absorbing material 70 and desiccant 60 from migrating into each other while allowing the flow of fluid through partition 80. In the example shown, partition 80 is a sintered bronze dispersion filter made of grade 12 bronze powder and has an outer diameter of approximately 1.063 inches, a thickness of approximately 0.125 inches, and has an edge that has a 2° draft for easier press fit into housing 10. Alternatively, partition 80 could also be a perforated metal filter, made of a metal such as McMaster Carr #9358T281, having an outer diameter of approximately 1.063 inches and a thickness of approximately 0.03 inches.

In addition, rather than using partition 80, migration or mixing of the oil vapor absorbing material 70 and desiccant 60 can be prevented by using particulate oil vapor absorbing material 70 and particulate desiccant 60 that have average particle sizes that are approximately equal. Examples of average particulate size being approximately equal would include particulate desiccant having beads of 4 to 8 mm and particulate oil vapor absorbing material having diameters of 3 to 4 mm and lengths that are approximately 2 to 2.5 times their diameter.

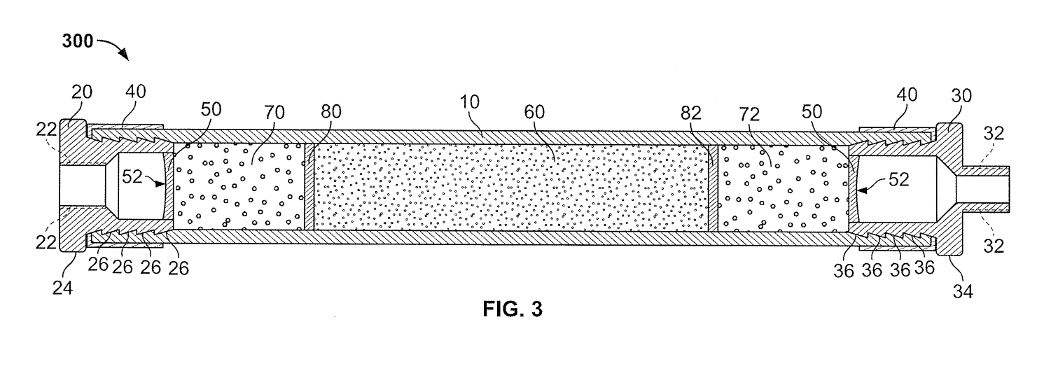

Referring to FIG. 3, a third example of an in-line dryer 300 is shown, which includes the same housing 10, connectors 20 and 30, ferrules 40, filters 50, desiccant material 60, oil vapor absorbing material 70, and permeable partition 80 shown in FIG. 2 and described above. In addition, in-line dryer 300 also contains a second quantity of oil vapor absorbing material 72 and a second permeable partition 82. Oil vapor absorbing material 72 is the same as oil vapor absorbing material 70 described above and is placed in housing 10 between desiccant 60 and connector 30. Permeable partition 82 is the same as partition 80 described above and is placed in housing 10 between desiccant 60 and oil vapor absorbing material 72. Oil vapor absorbing material 72 is positioned in housing 10 opposite oil vapor absorbing material 70 in order to make either end of housing 10 the entrance way for the compressed air of gas. As a result, any oil vapor carried by the compressed air or gas will be removed from the compressed gas or air before the compressed gas or air contacts desiccant 60.

The foregoing description of examples of the invention have been presented for purposes of illustration and description, and are not intended to be exhaustive or to limit the invention to the precise forms disclosed. The examples were selected to best explain the principles of the invention and their practical application to enable other skills in the art to best utilize the invention in various embodiments and various modifications as are suited to the particular use contemplated. It is intended that the scope of the invention not be limited by the specification, but be defined by the claims set forth below.

1. An in-line dryer for connecting to a compressed fluid delivery line, comprising:
a flexible housing comprising a first end and a second end, wherein at least a portion of the housing is translucent; and
a desiccant material disposed within the housing.

2. The in-line dryer of claim 1, wherein the housing comprises a tube.

3. The in-line dryer of claim 1, wherein the portion of the housing is transparent.

4. The in-line dryer of claim 1, wherein the housing is constructed of a reinforced ethyl vinyl acetate tubing to contain the compressed fluid at a predetermined operating pressure.

5. The in-line dryer of claim 1 wherein the desiccant comprises at least one of silica gel, activated alumina, and a molecular sieve.

6. The in-line dryer of claim 1, further comprising a first connector attached to the first end of the housing and a second connector attached to the second end of the housing.

7. The in-line dryer of claim 6, wherein the first and second connectors are selected from a group comprising male connectors and female connectors.

8. The in-line dryer of claim 1, further comprising a filter element positioned proximate to the first end.

9. The in-line dryer of claim 8, wherein the filter element is positioned between the desiccant and the first end.

10. The in-line dryer of claim 1, further comprising a filter element positioned proximate to the second end.

11. The in-line dryer of claim 10, wherein the filter element is positioned between the desiccant and the second end.

12. The in-line dryer of claim 8, wherein the filter element comprises a sintered bronze dispersion filter.

13. The in-line dryer of claim 1, wherein the housing is constructed of at least one of rubber, vinyl, polyvinyl chloride, and plastic.

14. An in-line dryer for connecting to a compressed fluid delivery line, comprising:
a housing comprising a first end and a second end;
a desiccant material disposed within the housing; and
a quantity of particulate oil vapor absorbing material disposed within the housing and positioned between the desiccant material and the first end of the housing.

15. The in-line dryer of claim 14, further comprising a second quantity of particulate oil vapor absorbing material disposed within the housing and positioned between the desiccant material and the second end of the housing.

16. The in-line dryer of claim 14, wherein the housing is constructed of at least one of vinyl, rubber, polyvinyl chloride, metal, and plastic and has sufficient strength to contain the compressed fluid at a predetermined operating pressure.

17. The in-line dryer of claim 14, wherein the housing is flexible.

18. The in-line dryer of claim 14, wherein the housing is translucent.

19. The in-line dryer of claim 14, wherein the housing is transparent.

20. The in-line dryer of claim 14, wherein the housing comprises reinforced ethyl vinyl acetate tubing.

21. The in-line dryer of claim 14, further comprising a first connector attached to the first end of the housing and a second connector attached to the second end of the housing.

22. The in-line dryer of claim 21, wherein the first and second connectors are selected from a group comprising male connectors and female connectors.

23. The in-line dryer of claim 14, wherein the desiccant material comprises at least one of silica gel, activated alumina, and a molecular sieve.

24. The in-line dryer of claims 14 and 15, wherein the particulate oil vapor absorbing material is selected from a group comprising activated carbon, polymeric compounds, and clays.

25. The in-line dryer of claim 14, wherein the desiccant material occupies approximately 60 to 80% of a volume of the housing and the quantity of particulate oil vapor absorbing material occupies approximately 20 to 40% of the volume of the housing.

26. The in-line dryer of claim 14, further comprising a filter element positioned within the housing proximate to the first end.

27. The in-line dryer of claim 26, wherein the filter element is positioned between the particulate oil vapor absorbing material and the first end.

28. The in-line dryer of claim 14, further comprising a filter element positioned within the housing proximate to the second end.

29. The in-line dryer of claim 28, wherein the filter element is positioned between the desiccant material and the second end.

30. The in-line dryer of claims 26 and 28, wherein the filter element is a sintered bronze dispersion filter.

31. The in-line dryer of claim 14, further comprising a permeable partition mounted within the housing between the desiccant material and the first quantity of particulate oil vapor absorbing material.

32. The in-line dryer of claim 14, further comprising:
a second quantity of particulate oil vapor absorbing material disposed within the housing and positioned between the desiccant material and the second end of the housing;
a first permeable partition mounted within the housing between the desiccant material and the first quantity of particulate oil vapor absorbing material; and
a second permeable partition mounted within the housing between the desiccant material and the second quantity of particulate oil vapor absorbing material.

33. An in-line dryer for connecting to a compressed fluid delivery line, comprising:
a housing;
a first particulate material disposed within the housing;
a second particulate material disposed within the housing; and
a permeable partition disposed within the housing and positioned between the first particulate matter and the second particulate matter.

34. The in-line dryer of claim 33, wherein the housing comprises a flexible, translucent tube.

35. The in-line dryer of claim 33, wherein the first particulate matter comprises a desiccant material.

36. The in-line dryer of claim 33, wherein the second particulate matter comprises an oil vapor absorbing material.
